(19) United States
(12) Patent Application Publication
(10) Pub. No.: US 2022/0181091 A1
(43) Pub. Date: Jun. 9, 2022

(54) METHOD FOR PRE-LITHIATING A LITHIUM-ION CAPACITOR

(71) Applicant: Beyonder AS, Sandnes (NO)

(72) Inventor: Fengliu Lou, Stavanger (NO)

(73) Assignee: Beyonder AS, Sandnes (NO)

(21) Appl. No.: 17/598,398

(22) PCT Filed: Apr. 2, 2020
(86) PCT No.: PCT/NO2020/050093

§ 371 Date: Sep. 27, 2021

(30) Foreign Application Priority Data
Apr. 4, 2019 (NO) 20190459

(51) Int. Cl. H01G 11/06; H01G 11/32; H01G 11/86

(52) U.S. Cl. CPC H01G 11/06; H01G 11/86; H01G 11/32

(57) ABSTRACT

A method is for pre-lithiating a lithium-ion capacitor, wherein the method has the steps of adsorbing lithium ions on an activated carbon electrode; constructing the lithium-ion capacitor by assembling the activated carbon electrode and a negative electrode in an electrolyte; and lithiating the anode by charging the lithium-ion capacitor after assembly.

### CROSS-REFERENCE TO RELATED APPLICATIONS

This application is the U.S. national stage application of International Application PCT/NO2020/050093, filed Apr. 2, 2020, which international application was published on Oct. 8, 2021, as International Publication WO 2020/204728 in the English language. The International Application claims priority of Norwegian Patent Application No. 20190459, filed Apr. 4, 2019. The international application and Norwegian application are both incorporated herein by reference, in entirety.

### FIELD AND BACKGROUND

The invention relates to a method for pre-lithiating a lithium-ion capacitor.

Lithium-ion (Li-ion) capacitors are hybrid systems which integrate a lithium-ion battery negative electrode, for example graphite, and a supercapacitor positive electrode, typically activated carbon, together. Therefore, they exhibit a high specific power, a good cyclic stability, and a moderate specific energy, so they have a wide range of potential applications. However, pre-lithiation of the anode with lithium ions is a prerequisite step to lower the potential of the anode, thus widening the operation voltage window and increasing the specific energy. Various methods have been proposed for the pre-lithiation of the lithium-ion capacitor negative electrode. They can be divided into three groups, namely methods using lithium metal, lithium-containing compounds, or lithium ions.

U.S. Pat. No. 6,862,168 B2 discloses use of a sacrificial metallic lithium electrode, which is partially or completely dissolved during the first charge. A drawback is that metal foils with penetrating holes, which are expensive, are required as current collectors to let the lithium ions pass through. Additionally, the pre-lithiation process is very slow.

Stabilized lithium metal particles have also been used for the pre-lithiation. Lithium carbonate (Cao, W. J. and J. P. Zheng, Li-ion capacitors with carbon cathode and hard carbon/stabilized lithium metal powder anode electrodes. Journal of Power Sources, 2012. 213: p. 180-185) or lithium hexafluorophosphate (US 2017/0062142 A1 and US 2014/0146440 A1) have been coated on the surface of lithium metal particles to prevent its reactivity with oxygen. However, a drying room is still required for handling stabilized lithium metal particles.

Lithium-containing compounds have also been utilized as lithium sources for the pre-lithiation of lithium-ion capacitors. Kim and co-workers (Park, M.-S., et al., A Novel Lithium-Doping Approach for an Advanced Lithium Ion Capacitor. Advanced Energy Materials, 2011. 1(6): p. 1002-1006.) utilized a lithium transition metal oxide mixed with activated carbon as positive electrode, thereby providing lithium cations to the negative electrode during the first charge step. The transition metal oxide cannot be lithiated again during the following discharge process. The delithiated metal oxide will be left in the positive electrode as electrochemical inactive materials. Therefore, the specific energy of the cell is reduced.

Recently, F. Beguin and co-workers (Jeżowski, P., et al., Safe and recyclable lithium-ion capacitors using sacrificial organic lithium salt. Nature Materials, 2017) employed a mixture of sacrificial organic lithium salt and activated carbon as positive electrode. The lithium salt is oxidized, and lithium cations are released to the negative electrode during the first charge. The oxidized salt will be dissolved into the electrolyte. However, the proposed salt is air-sensitive, which makes it difficult to handle.

Lithium salt in the electrolyte has also been considered as lithium sources for prelithiation. F. Beguin and co-workers employed a specific charging protocol to provide the negative electrode with lithium cations from the electrolyte (Khomenko, V., E. Raymundo-Piñero, and F. Béguin, High-energy density graphite/AC capacitor in organic electrolyte. Journal of Power Sources, 2008, 177(2): p. 643-651). Stefan et al. pre-lithiated the negative electrode by oxidizing the lithium salt in the electrolyte (US 2015/0364795 A1). Lithium salts normally have a limited solubility in the organic solvent, so the conductivity of the electrolyte is reduced, and thereby also the specific power.

In US 2002/0122986 A1 it is disclosed to store lithium ions in a separator which is made with molecular sieves to compensate the lithium ions lost in lithium ion battery, thus extending the life time of lithium ion batteries. However, the cost is too high for commercial application, and the lithium ion storage capacity is also very limited.

US2018197691A1 discloses another preparation method of a lithium-ion capacitor.

Although all these approaches are effective or partially effective in pre-lithiating the negative electrode of lithium-ion capacitor, they all have their drawbacks. None of the known methods can meet the requirements of being efficient, having low cost, being safe to handle, and having no significant side effect at the same time.

### SUMMARY

The invention has for its object to remedy or to reduce at least one of the drawbacks of prior art, or at least provide a useful alternative to prior art. The object is achieved through features, which are specified in the description below and in the claims that follow. The invention is defined by the independent patent claims, while the dependent claims define advantageous embodiments of the invention.

In a first aspect the invention relates more particularly to a method for pre-lithiating a lithium-ion capacitor, wherein the method comprises the steps of adsorbing lithium ions on an activated carbon electrode; constructing the lithium-ion capacitor by assembling the activated carbon electrode and a negative electrode in an electrolyte; and lithiating the anode by charging the lithium-ion capacitor after assembly. When adsorbed onto the activated carbon, the lithium ions can be incorporated into the lithium-ion capacitor in a safe, efficient, and controlled manner, and no undesired additional material is introduced. The anode material may for example comprise graphite, hard carbon, soft carbon, a metal alloy, silicon, silicon oxide, metal oxide, carbon nanotubes, carbon nanofiber, graphene, or any combination among them.

In one embodiment, the step of adsorbing lithium ions onto an activated carbon electrode may comprise reducing the electrochemical potential of the activated carbon electrode in a lithium ion-containing electrolyte. This may for example be realized through discharging the activated carbon-containing cell, where activated carbon serves as a positive electrode, or charging the activated carbon-containing cell, where activated carbon serves as negative electrode. This lithium ion adsorption process can be conducted in a bath to bath way or continuous way. In this way the positively charged lithium ions will be attracted to the activated carbon for improved adsorption.

In the step of lithiating the anode by charging the lithium-ion capacitor after assembly, lithium ions from the activated carbon will pass through the electrolyte towards the anode. Pre-lithiation of the anode has the effect of lowering the potential of the anode to allow for a higher output voltage of the lithium-ion capacitor. If the anode for example comprises graphite, lithium ions may be intercalated into the graphite, which causes the potential to be lowered. The degree to which the potential of the anode is lowered due to pre-lithiation may vary slightly depending on the anode material.

The invention further relates to a pre-lithiated lithium-ion capacitor comprising a negative electrode, an activated carbon electrode, and an electrolyte, wherein the pre-lithiation of the lithium-ion capacitor is obtainable using the method according to the first aspect of the invention.

### BRIEF DESCRIPTION OF THE DRAWINGS

In the following is described examples of preferred embodiments. The examples are supplemented with accompanying drawings, wherein:

FIG. 1 Shows a part of a surface of an activated carbon electrode without (FIG. 1A) and with (FIG. 1B) adsorbed lithium ions;

FIG. 2 Shows the capacity as a function of cycle number of the lithium-ion capacitor assembled in example 1 compared with reference example;

FIG. 3 Shows the capacity as a function of cycle number of the lithium-ion capacitor assembled in example 2 compared with reference example; and

FIG. 4 Shows the capacity as a function of cycle number of the lithium-ion capacitor assembled in example 3 compared with reference example.

### DETAILED DESCRIPTION OF THE EMBODIMENTS

In the examples, the activated carbon electrode is prepared by coating an aqueous-based slurry containing activated carbon YEC-8B (Fuzhou Yihuan Carbon Co., Ltd), carbon black Super C65 (Imerys Graphite & Carbon Switzerland Ltd), commercially available Carboxymethyl cellulose, and styrene butadiene rubber latex with a mass ratio of 88:8.0:1.5:2.5 on an etched aluminium foil. Graphite electrodes and silicon/carbon composite electrodes are purchased from Customcells Itzehoe GmbH with area capacity of 1.1 mAh/cm².

### Reference Cell (Prior Art)

A split lithium-ion capacitor cell (EL-Cell GmbH) with activated carbon electrode as working electrode (diameter ø16 mm), graphite electrode as counter electrode (diameter ø16 mm), and a commercial lithium-ion battery electrolyte as electrolyte is assembled. The cell is charged and discharged at current densities of 0.025, 0.1, and 0.5 mA/cm² at the beginning to form a stable solid electrolyte interface film on the graphite electrode.

The cell can be charged and discharged between 2.0 and 4.0 V but with low capacity and very fast capacity fading.

### EXAMPLE 1

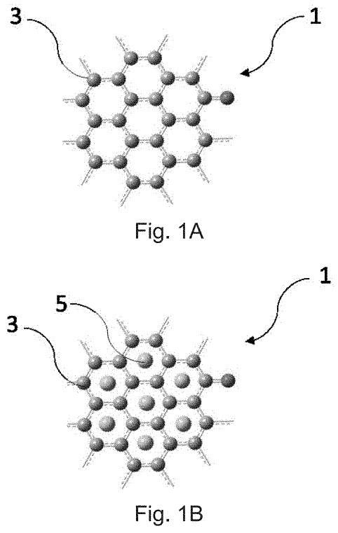

A split cell (EL-Cell GmbH) with activated carbon electrode as working electrode (diameter ø16 mm), lithium foil as counter electrode (diameter ø16 mm), and a commercial lithium-ion battery electrolyte as electrolyte is discharged down to 1.5 V vs Li and then disassembled. FIG. 1 illustrates the generally accepted mechanism lithium ion-adsorption on an activated carbon surface 1, which comprises a hexagonal lattice of carbon atoms 3. The activated carbon surface 1 is shown without (FIG. 1A) and with (FIG. 1B) adsorbed lithium ions 5. The A lithium-ion capacitor split cell is thereafter assembled with the lithium ion-adsorbed activated carbon electrode as positive electrode, graphite electrode as negative electrode, and 1.2M LiPF₆ in 3:7 v/v Ethylene Carbonate/Ethyl Methyl Carbonate as electrolyte. The cell is charged and discharged at current densities of 0.025, 0.1, and 0.5 mA/cm² at the beginning to form a stable solid electrolyte interface film on the graphite electrode.

The cell can be charged and discharged properly between 2.0 and 4.0 V with a specific energy up to 120 Wh/kg and a power up to 12 kW/kg based on the electrode material from both electrodes.

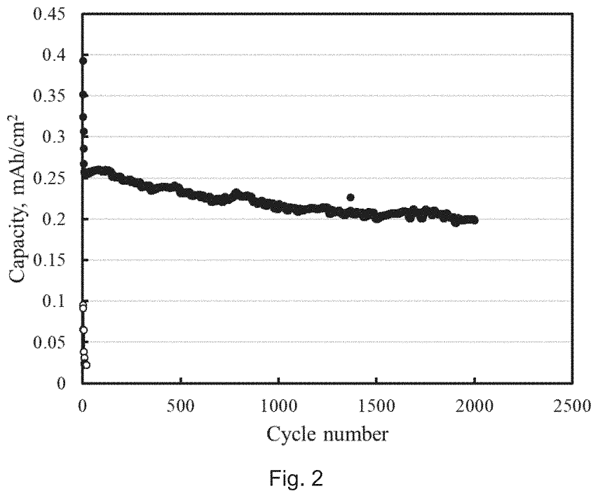

The cyclic stability of the assembled cell is indicated in FIG. 2, which shows the capacity of the cell from example 1 (filled circles) and the reference cell (open circles) as a function of cycle number. The cycle number is the number of times the cell has been charged and discharged. The improved capacity and cyclic stability are clear from this figure.

### EXAMPLE 2

A split cell (EL-Cell GmbH) with activated carbon electrode as working electrode (diameter ø16 mm), lithium foil as counter electrode (diameter ø16 mm), and commercial lithium ion battery electrolyte as electrolyte is discharged down to 1.75 V vs lithium and then disassembled. A lithium-ion capacitor split cell is assembled with the lithium ion-adsorbed activated carbon electrode as positive electrode, graphite electrode as negative electrode, and lithium ion battery electrolyte as electrolyte. The cell is charged and discharged at current densities of 0.025, 0.1, and 0.5 mA/cm² at the beginning to form a stable solid electrolyte interface film on the graphite electrode.

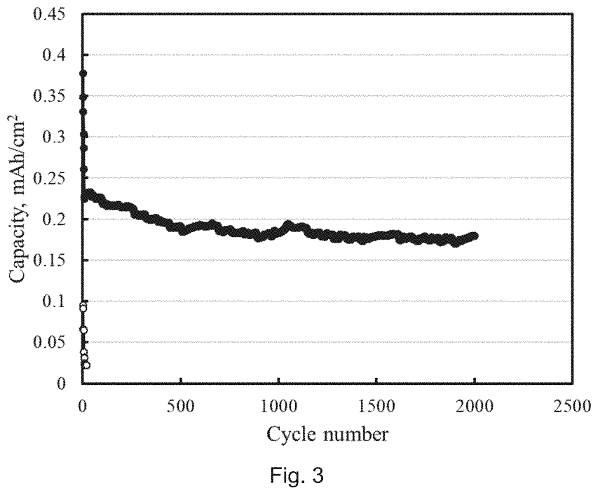

The cell can be charged and discharged properly between 2.2 and 4.2 V with a specific energy up to 100 Wh/kg based on the electrode material from both electrodes. The cyclic stability of the assembled cell is indicated in FIG. 3, which shows the capacity of the cell from example 2 (filled circles) and the reference cell (open circles) as a function of cycle number.

### EXAMPLE 3

A symmetrical supercapacitor split cell (EL-Cell GmbH) with activated carbon electrodes (diameter ø16 mm) and 1 M LiTFSI in water as electrolyte is charged up to 1.25 V and then disassembled. A lithium-ion capacitor split cell is assembled with the lithium ion-adsorbed activated carbon electrode as positive electrode, silicon/carbon composite electrode (diameter ø16 mm) as negative electrode, and lithium ion battery electrolyte as electrolyte. The cell is charged and discharged at current densities of 0.025, 0.1, and 0.5 mA/cm² at the beginning to form a stable solid electrolyte interface film on the silicon/carbon electrode.

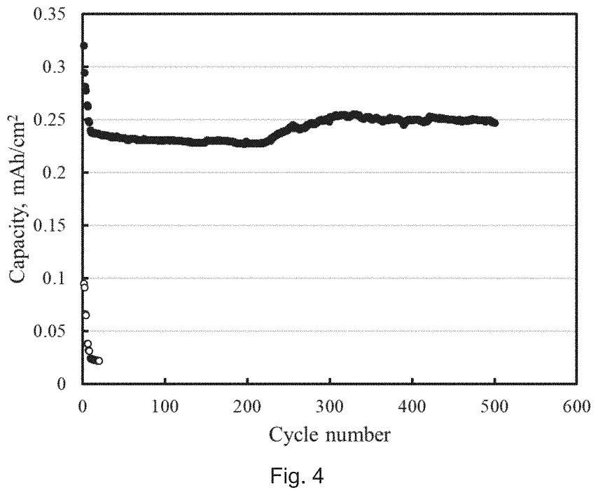

The cell can be charged and discharged properly between 2.0 and 4.0 V with a specific energy up to 120 wh/kg based on the electrode material from both electrodes. The cyclic stability of the assembled cell is indicated in FIG. 4, which shows the capacity of the cell from example 2 (filled circles) and the reference cell (open circles) as a function of cycle number.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

1. A method for pre-lithiating a lithium-ion capacitor, wherein the method comprises the steps of
adsorbing lithium ions on an activated carbon electrode;
constructing the lithium-ion capacitor by assembling the activated carbon electrode and a negative electrode in an electrolyte; and
lithiating the anode by charging the lithium-ion capacitor after assembly.

2. The method according to claim 1, wherein the step of adsorbing lithium ions on an activated carbon electrode comprises reducing the electrochemical potential of the activated carbon electrode in a lithium ion-containing electrolyte.
